(19) United States
(12) Patent Application Publication
(10) Pub. No.: US 2002/0091773 A1
(43) Pub. Date: Jul. 11, 2002

(54) System and method for routing an incoming electronic message from a sender to a recipient where an electronic message address of the recipient fails to match a naming convention applicable to the recipient

(76) Inventors: Shyamal Roy Chowdhry, San Jose, CA (US); David W. Slaby, Santa Clara, CA (US)

Correspondence Address: James E. Eakin, McDermott, Will & Emery, 3150 Porter Ave., Palo Alto, CA, 94304-1212, US

(21) Appl. No.: 09/755,750

(22) Filed: Jan. 5, 2001

(51) Int. Cl. G06F 15/16

(52) U.S. Cl. 709/206

(57) ABSTRACT

The present invention provides a system and method for routing an incoming electronic message from a sender to a recipient where an electronic message address of the recipient fails to match a naming convention applicable to the recipient. The system and method, in an exemplary embodiment, includes (1) receiving a recipient name of the electronic message address of the recipient, (2) creating one or more logical combinations of the recipient name according to one or more naming conventions, (3) comparing each of the one or more logical combinations of the recipient name with each name in a name list, and (4) handling the electronic message for delivery to the recipient if there are one or more matches between the one or more logical combinations of the recipient name and each name in the name list.

### FIELD OF THE INVENTION

The present invention relates to electronic messages. More particularly, the invention relates to a system and method for routing an incoming electronic message from a sender to a recipient where an electronic message address of the recipient fails to match a naming convention applicable to the recipient.

### BACKGROUND OF THE INVENTION

Current host electronic mail (e-mail) servers have non-standard conventions for allocating e-mail addresses for recipients. For example, a recipient, such as John Smith, at a host site, such as http://www.xxx.com, may be allocated any one of the following exemplary e-mail addresses:

(1) jsmith@xxx.com;

(2) j.smith@xxx.com;

(3) john.smith@xxx.com;

(4) john_smith@xxx.com;

(5) johnsmith@xxx.com;

(6) john.s@xxx.com; and

(7) js@xxx.com.

The part of an e-mail address corresponding to the host name of the host site of a recipient and located after the @ symbol in the e-mail address may be called the host name, such as xxx.com. The host name may also be called the unique uniform resource locator (URL). The part of an e-mail address corresponding to the recipient's identifier and located before the @ symbol in the e-mail address may be called the recipient name, such as jsmith. The recipient name may also be called the unique identifier.

A sender of an e-mail message to a recipient may know, with some ease, the host name of the recipient's e-mail address. However, the sender may not know the precise recipient name of the recipient's e-mail address.

If the sender were to attempt to send an e-mail message to a recipient who had a correct e-mail address, such as jsmith@xxx.com, by directing the e-mail message to an incorrect e-mail address, such as j.smith@xxx.com, the e-mail message would not reach the recipient.

In other words, in current e-mail systems, the sender of an e-mail message to a recipient must know the precise recipient name as well as the precise host name of the e-mail address of the recipient in order to successfully send the e-mail message to the recipient.

FIG. 1 is a block diagram of a prior art e-mail communication system 100. When a sender sends an e-mail message to a recipient, a sender's e-mail client 110 sends the e-mail message to a sender's e-mail server 120. Then, e-mail server 120 sends the e-mail message to a client's e-mail server 130. Within client's e-mail server 130, a message handling module 134 receives the e-mail message and compares the recipient name from the e-mail message to names from a name list 132. Only if the recipient name matches a single name from name list 132, then message handling module 134 sets a notification that the e-mail message has been received for a recipient's client 140. Otherwise, message handling module 134 notifies sender's e-mail server 120 that the e-mail message is undeliverable.

As a result, current e-mail systems, such as e-mail system 100, cannot intelligently deal with the following:

(1) imprecise recipient names in e-mail addresses; or

(2) multiple matches of recipient names with names from name list 132.

The aforementioned problems are also encountered when senders attempt to send other types of electronic messages to recipients. For example, senders of wireless protocol-based communications also encounter the aforementioned problems. In addition, senders of communications to Internet-enabled or intranet-enabled or extranet-enabled devices, Internet appliances, also encounter the aforementioned problems. Such Internet appliances may operate under a wireless protocol, such as the Bluetooth protocol as specified by LM Ericsson AB of Sweden.

Therefore, a system and method for routing an incoming electronic message from a sender to a recipient where an electronic message address of the recipient fails to match a naming convention applicable to the recipient is needed.

### SUMMARY OF THE INVENTION

The present invention provides a system and method for routing an incoming electronic message from a sender to a recipient where an electronic message address of the recipient fails to match a naming convention applicable to the recipient. The system and method, in an exemplary embodiment, includes (1) receiving a recipient name of the electronic message address of the recipient, (2) creating one or more logical combinations of the recipient name according to one or more naming conventions, (3) comparing each of the one or more logical combinations of the recipient name with each name in a name list, and (4) handling the electronic message for delivery to the recipient if there are one or more matches between the one or more logical combinations of the recipient name and each name in the name list.

In an exemplary embodiment, the handling includes (a) determining if there are multiple matches between the one or more logical combinations of the recipient name and each name in the name list, (b) sending a matched name from the name list to a message handling module of the electronic message server of the recipient if there is only one match, (c) creating a notification of the receipt of the electronic message for a client of the recipient if there is only one match, (d) notifying the message handling module that multiple matches have been found if there are multiple matches, and (e) sending a notification to an electronic message server of the sender that multiple matches have been found if there are multiple matches.

In an exemplary embodiment, the system and method includes (1) receiving a recipient name of the electronic message address of the recipient, (2) creating one or more logical combinations of each entry of a name list in the electronic message server of the recipient according to one or more naming conventions, (3) comparing each of the one or more logical combinations of each entry of the name list with the recipient name, and (4) handling the electronic message for delivery to the recipient if there are one or more matches between the one or more logical combinations of each entry of the name list and the recipient name.

### THE FIGURES

FIG. 1 is a block diagram of a prior art e-mail system.

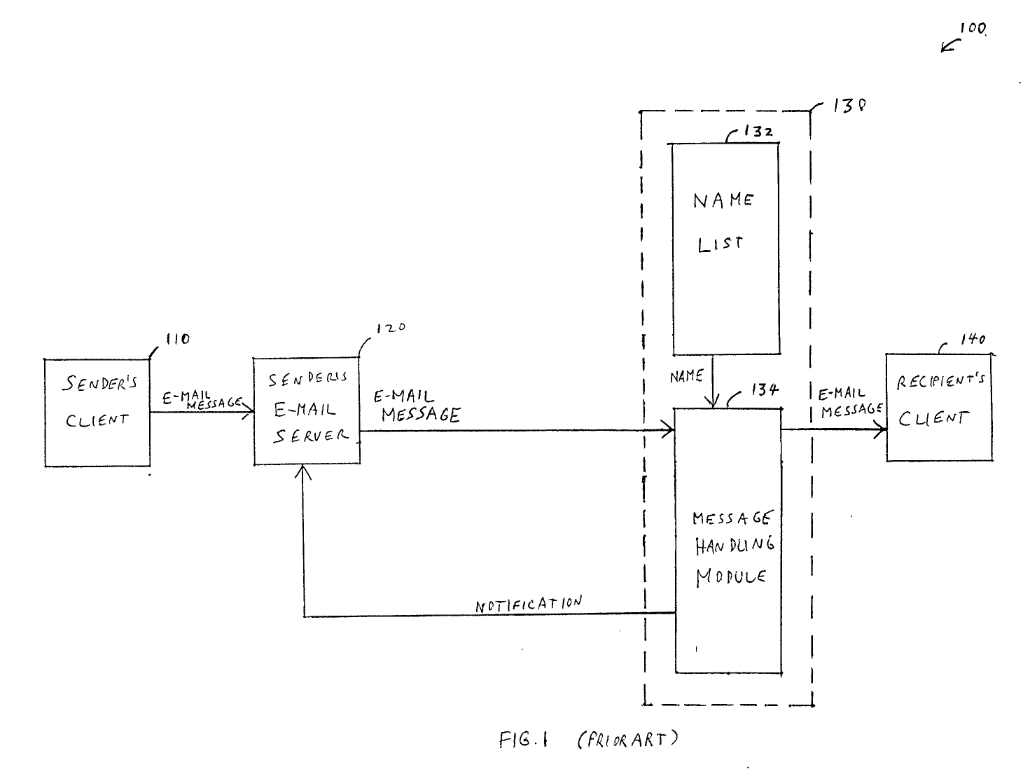

FIG. 2 is a block diagram of a system and method for routing an incoming electronic message from a sender to a recipient where an electronic message address of the recipient fails to match a naming convention applicable to the recipient in accordance with an exemplary embodiment of the present invention.

FIG. 3A is a flowchart of a method for routing an incoming electronic message from a sender to a recipient where an electronic message address of the recipient fails to match a naming convention applicable to the recipient when a parser performs an intelligent table-lookup by altering a recipient name, in accordance with an exemplary embodiment of the present invention.

FIG. 3B is a flowchart of a method for routing an incoming electronic message from a sender to a recipient where an electronic message address of the recipient fails to match a naming convention applicable to the recipient when a parser performs an intelligent table-lookup by altering a name list, in accordance with an exemplary embodiment of the present invention.

### DETAILED DESCRIPTION OF THE INVENTION

The present invention provides a system and method for routing an incoming electronic message from a sender to a recipient where an electronic message address of the recipient fails to match a naming convention applicable to the recipient. In an exemplary embodiment, a naming convention is applicable to the recipient if the naming convention matches the naming convention of an electronic message server of the recipient.

### System and Method

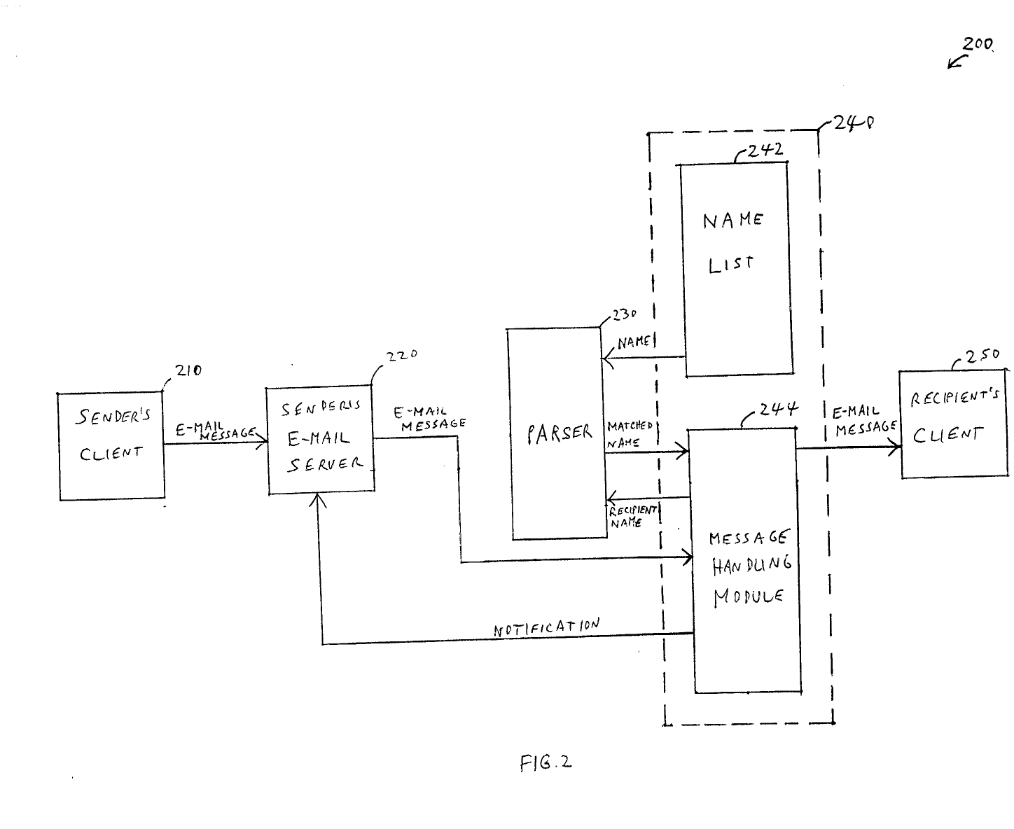

Referring to FIG. 2, a system and method 200 for routing an incoming electronic message from a sender to a recipient where an electronic message address of the recipient fails to match a naming convention applicable to the recipient in accordance with an exemplary embodiment of the present invention is shown. In an exemplary embodiment, an e-mail is an electronic message. System and method 200 includes a sender's client 210, a sender's e-mail server 220, a parser 230, a recipient's e-mail server 240, and a recipient's e-mail client 250. Recipient's e-mail server 240 includes a name list 242 and a message handling module 244.

As shown in FIG. 2, in an exemplary embodiment, the present invention provides parser 230. Parser 230 receives an incoming e-mail message addressed to a recipient, such as to john.smith@xxx.com, from sender's e-mail server 220. Parser 230 then reads the recipient name, such as john.smith, in the e-mail message. Then, parser 230 performs an intelligent table-lookup of name list 242 in order (1) to establish the identity of the correct recipient of the e-mail message, and (2) (a) to ensure successful communication of the email message or (b) to notify the sender of an undelivered e-mail message.

In an exemplary embodiment, parser 230 performs the intelligent table-lookup on name table 242 in one or more of the following ways:

(1) by altering the recipient name; and

(2) by altering name list 242.

### Performing the Intelligent Table-Lookup by Altering the Recipient Name

When performing the intelligent table-lookup on name table 242 by altering the recipient name, parser 230 creates, (1) via combinatorial logic, multiple combinations of the recipient name and (2) via naming conventions, logical combinations of the recipient name, such as john.smith, as in the following examples:

(1) jsmith;

(2) j.smith;

(3) john.smith;

(4) john_smith;

(5) johnsmith;

(6) john.s; and

(7) js.

In an exemplary embodiment, one or more of the naming conventions used to create the combinations are configurable. In an exemplary embodiment, the naming conventions manipulate one or more variables of the recipient name.

### Recipient Names With Connecting Characters

In an exemplary embodiment, the variables of a recipient name with a connecting character include one or more of the following:

(1) first name of the recipient;

(2) last name of the recipient;

(3) first initial of the first name of the recipient;

(4) first initial of the last name of the recipient; and

(5) connecting character.

In an exemplary embodiment, a combination of (1) the first name of the recipient, (2) the last name of the recipient, and (5) a connecting character form a recipient name. In an exemplary embodiment, a combination of (3) the first initial of the first name of the recipient, (4) the first initial of the last name of the recipient, and (5) a connecting character form a recipient name. In an exemplary embodiment, a combination of (3) the first initial of the first name of the recipient, (2) the last name of the recipient, and (5) a connecting character form a recipient name. In an exemplary embodiment, a combination of (1) the first name of the recipient, (4) the first initial of the last name of the recipient, and (5) a connecting character form a recipient name.

In an exemplary embodiment, the connecting character may be one or more of the following: (1)“.”;(2)“_{—”; and (}3) “-”.

In an exemplary embodiment, a naming convention instructs parser 230 to interpret (1) the part of the recipient name before the connecting character as the first name of the recipient and (2) the part of the recipient name after the connecting character to be the last name of the recipient.

In an exemplary embodiment, a naming convention instructs parser 230 to combine the first initial of the first name and the first initial of the last name to form a combination. In an exemplary embodiment, a naming convention instructs parser 230 to combine the first name of the recipient with the first initial of the last name of the recipient to form a combination. In an exemplary embodiment, a naming convention instructs parser 230 to combine the last name of the recipient with the first initial of the first name of the recipient to form a combination.

### Recipient Names Without Connecting Characters

In an exemplary embodiment, the variables of a recipient name without a connecting character include one or more of the following:

(1) first name of the recipient;

(2) last name of the recipient;

(3) first initial of the first name;

(4) first initial of the middle name; and

(4) first initial of the last name.

### Two Letters

In an exemplary embodiment, a naming convention instructs parser 230 to interpret a recipient name without a connecting character and consisting of two letters to include the first initial of the first name of the recipient and the first initial of the last name of the recipient. In a particular embodiment, a naming convention instructs parser 230 to interpret the first character of a two-letter recipient name to be the first initial of the first name of the recipient and the last character of the two-letter recipient name to be the first initial of the last name of the recipient. In an alternative embodiment, instructs parser 230 to interpret the first character of a two-letter recipient name to be the first initial of the last name of the recipient and the last character of the two-letter recipient name to be the first initial of the first name of the recipient.

In an exemplary embodiment, a naming convention instructs parser 230 to combine the first initial of the first name and the first initial of the last name to form a combination.

### Three Letters

In an exemplary embodiment, a naming convention instructs parser 230 to interpret a recipient name without a connecting character and consisting of three letters to include the first initial of the first name of the recipient, the first initial of the middle name of the recipient, and the first initial of the last name of the recipient. In a particular embodiment, a naming convention instructs parser 230 to interpret the first character of a three-letter recipient name to be the first initial of the first name of the recipient, the second character of the three-letter recipient name to be the first initial of the middle name of the recipient, and the last character of the three-letter recipient name to be the first initial of the last name of the recipient. In an alternative embodiment, instructs parser 230 to interpret the first character of a three-letter recipient name to be the first initial of the last name of the recipient, the second character of the three-letter recipient name to be the first initial of the middle name of the recipient, and the last character of the three-letter recipient name to be the first initial of the first name of the recipient.

In an exemplary embodiment, a naming convention instructs parser 230 to combine the first initial of the first name, the first initial of the middle name, and the first initial of the last name to form a combination.

### More than Three Letters

In an exemplary embodiment, a naming convention instructs parser 230 to interpret a recipient name without connecting characters and with more than three letters to include the last name of the recipient in the last set of characters of the recipient name. In an alternative embodiment, a naming convention instructs parser 230 to interpret a recipient name without connecting characters and with more than three letters to include the last name of the recipient in the first set of characters of the recipient name.

In an exemplary embodiment, a naming convention instructs parser 230 to form combinations out of the first sets of characters of the recipient name. In an exemplary embodiment, a naming convention instructs parser 230 to form combinations out of the last sets of characters of the recipient name.

### Comparisons

Parser 230 then compares each of the aforementioned combinations of the recipient name with each name in name list 242. This comparison compares, character-by-character, each of the combinations with each name in name list 242.

### Performing the Intelligent Table-Lookup by Altering the Name List

When performing the intelligent table-lookup on name list 242 by altering name list 242, parser 230 creates, (1) via combinatorial logic, multiple combinations of the recipient name and (2) via naming conventions, logical combinations of each entry in name list 242. For example, if name list 242 includes an entry such as john.smith, parser 242 creates one or more of the following combinations of entry john.smith:

(1) john.smith;

(2) jsmith;

(3) j.smith;

(4) john.smith;

(5) john_smith;

(5) johnsmith;

(6) john.s; and

(7) js.

In an exemplary embodiment, parser 230 creates ten combinations for each entry in name list 242.

In an exemplary embodiment, parser 230 creates combinations according to naming conventions similar to the aforementioned naming conventions.

### Comparisons

Parser 230 then compares the recipient name with each of the aforementioned combinations of each entry of name list 242. This comparison compares, character-by-character, the recipient name with each of the combinations of each entry in name list 242.

### Processing the Message

If there is a match, parser 230 sends the matched recipient name to message handling module 244. Then, message handling module 244 creates a notification of the receipt of the e-mail message for recipient's client 250.

Otherwise, parser 230 notifies message handling module 244 that no match has been found for the recipient name. Then, message handling module 244 sends a “mail undeliverable” message to sender's e-mail server 220.

### Operations

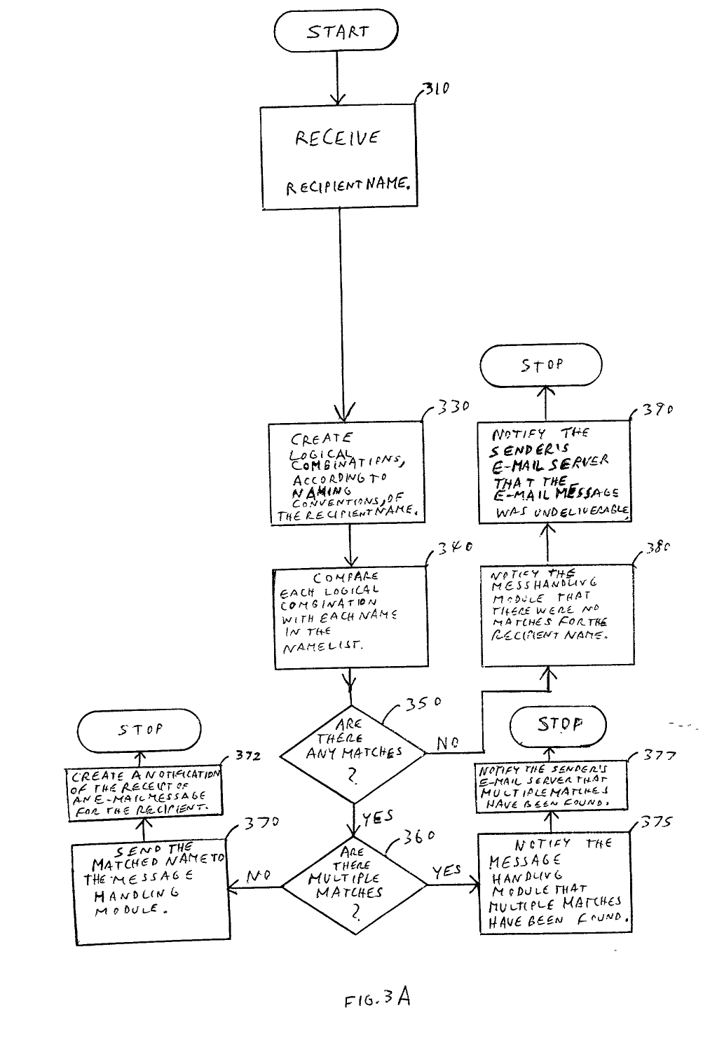

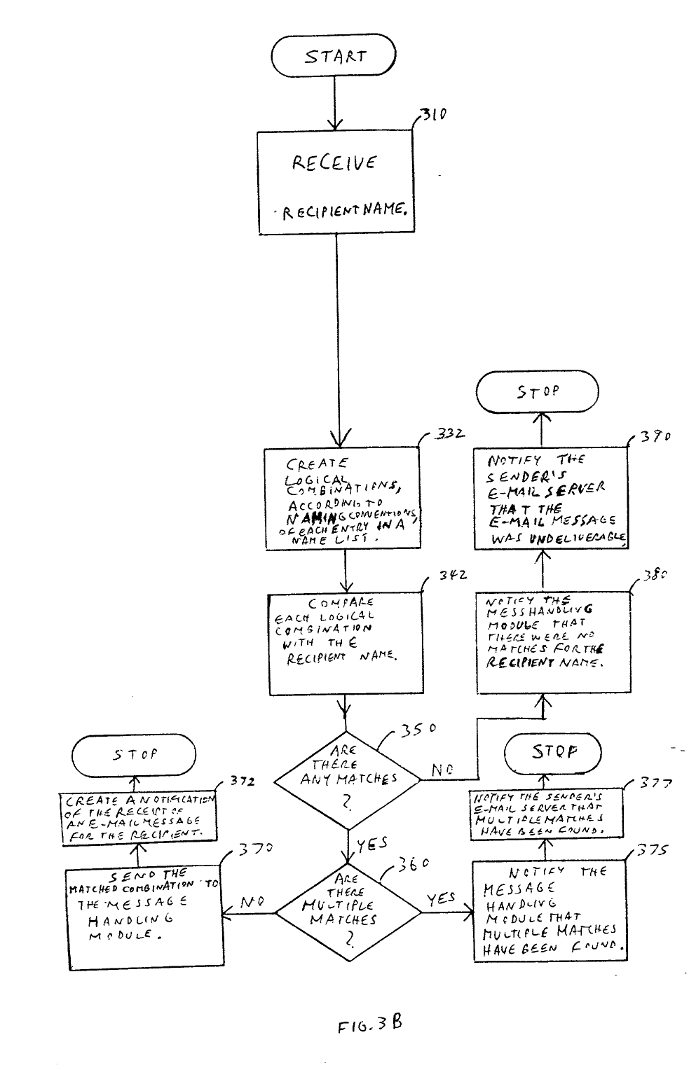

Referring to FIGS. 3A and 3B, flowcharts of the method for routing an incoming electronic message from a sender to a recipient where an electronic message address of the recipient fails to match a naming convention of an electronic message server of the recipient in accordance with an exemplary embodiment of the present invention is shown. In step 310, parser 230 receives a recipient name of an e-mail address of an incoming email message.

### Performing the Intelligent Table-Lookup by Altering the Recipient Name

Referring to FIG. 3A, in step 330, if parser 230 is to perform the intelligent tablelookup by altering the recipient name, parser 230 creates one or more logical combinations of the recipient name according to one or more of the aforementioned naming conventions. Then, in step 340, parser 230 compares each of the one or more logical combinations with each name in name list 242.

In step 350, parser 230 determines if there are any matches between any of the one or more logical combinations and the names in name list 242.

If parser 230 determines there are no such matches, then, in step 380, parser 230 notifies message handling module 244 that there were no matches for the recipient name. Then, in step 390, message handling module 244 notifies sender's e-mail server 220 that the e-mail message was undeliverable.

If parser 230 does find a match in step 350, then, parser 230 determines, in step 360, if there are multiple matches. If parser 230 determines that there is only one match, parser 230 sends, in step 370, the matched name from name list 242 to message handling module 244. In step 372, message handling module 244 then creates a notification of the receipt of the e-mail message for recipient's client 250.

### Performing the Intelligent Table-Lookup by Altering the Name List

Referring to FIG. 3B, in step 332, if parser 230 is to perform the intelligent tablelookup by altering name list 242, parser 230 creates one or more logical combinations of each entry of name list 242 according to one or more of the aforementioned naming conventions. Then, in step 342, parser 230 compares each of the one or more logical combinations with the recipient name.

In step 350, parser 230 determines if there are any matches between the recipient name and any of the one or more logical combinations of each entry in name list 242.

If parser 230 determines there are no such matches, then, in step 380, parser 230 notifies message handling module 244 that there were no matches for the recipient name. Then, in step 390, message handling module 244 notifies sender's e-mail server 220 that the e-mail message was undeliverable.

If parser 230 does find a match in step 350, then, parser 230 determines, in step 360, if there are multiple matches. If parser 230 determines that there is only one match, parser 230 sends, in step 370, a matched combination from name list 242 to message handling module 244. In step 372, message handling module 244 then creates a notification of the receipt of the e-mail message for recipient's client 250.

### Multiple Matches

Referring to FIGS. 3A and 3B, if parser 230 determines that there are multiple matches, then, in step 375, parser 230 notifies message handling module 244 that multiple matches have been found. Then, in step 377, in an exemplary embodiment, message handling module 244 sends a notification to sender's e-mail server 220 that multiple matches have been found.

For example, if jsmith@xxx.com were the e-mail address of an e-mail message from a sender to a recipient, and, if parser 230 finds, for example, john.smith and jeff.smith as matches, (1) parser 230 notifies message handling module 244 that multiple matches have been found, and, (2) then, message handling module 244 sends a notification to sender's e-mail server 220 indicating the following:

(1) “Did you want john.smith or jeff.smith?”;

(2) “Two matches have been found.”; and

(3) “If one of these is right, please re-submit your e-mail message to the appropriate e-mail address of the recipient.”

### Conclusion

The present invention relates to electronic messages. More particularly, the invention relates to a system and method for routing an incoming electronic message from a sender to a recipient where an electronic message address of the recipient fails to match a naming convention applicable to the recipient.

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

We claim:

1. A method for routing an incoming electronic message from a sender to a recipient where an electronic message address of the recipient fails to match a naming convention applicable to the recipient, comprising:
receiving a recipient name of the electronic message address of the recipient;
creating one or more logical combinations of the recipient name according to one or more naming conventions;
comparing each of the one or more logical combinations of the recipient name with each name in a name list; and
handling the electronic message for delivery to the recipient if there are one or more matches between the one or more logical combinations of the recipient name and each name in the name list.

2. The method of claim 1 further comprising notifying the sender that the electronic message is undeliverable if there are no matches between the one or more logical combinations of the recipient name and each name in the name list.

3. The method of claim 2 wherein the notifying comprises:
notifying a message handling module of the electronic message server of the recipient that there are no matches for the recipient name; and
notifying an electronic message server of the sender that the electronic message was undeliverable.

4. The method of claim 1 wherein the handling comprises:
determining if there are multiple matches between the one or more logical combinations of the recipient name and each name in the name list;
sending a matched name from the name list to a message handling module of the electronic message server of the recipient if there is only one match;
creating a notification of the receipt of the electronic message for a client of the recipient if there is only one match;
notifying the message handling module that multiple matches have been found if there are multiple matches; and
sending a notification to an electronic message server of the sender that multiple matches have been found if there are multiple matches.

5. A method for routing an incoming electronic message from a sender to a recipient where an electronic message address of the recipient fails to match a naming convention applicable to the recipient, comprising:
receiving a recipient name of the electronic message address of the recipient;
creating one or more logical combinations of each entry of a name list in the electronic message server of the recipient according to one or more naming conventions;
comparing each of the one or more logical combinations of each entry of the name list with the recipient name; and
handling the electronic message for delivery to the recipient if there are one or more matches between the one or more logical combinations of each entry of the name list and the recipient name.

6. The method of claim 5 further comprising notifying the sender that the electronic message is undeliverable if there are no matches between the one or more logical combinations of each entry of the name list and the recipient name.

7. The method of claim 6 wherein the notifying comprises:
notifying a message handling module of the electronic message server of the recipient that there are no matches for the recipient name; and
notifying an electronic message server of the sender that the electronic message was undeliverable.

8. The method of claim 5 wherein the handling comprises:
determining if there are multiple matches between the one or more logical combinations of each entry of the name list and the recipient name;
sending a matched combination to a message handling module of the electronic message server of the recipient if there is only one match;
creating a notification of the receipt of the electronic message for a client of the recipient if there is only one match;
notifying the message handling module that multiple matches have been found if there are multiple matches; and
sending a notification to an electronic message server of the sender that multiple matches have been found if there are multiple matches.

9. A system for routing an incoming electronic message from a sender to a recipient where an electronic message address of the recipient fails to match a naming convention applicable to the recipient, comprising:
a receiving module configured to receive a recipient name of the electronic message address of the recipient;
a first creating module configured to create one or more logical combinations of the recipient name according to one or more naming conventions;
a comparing module configured to compare each of the one or more logical combinations of the recipient name with each name in a name list; and
a handling module configured to handle the electronic message for delivery to the recipient if there are one or more matches between the one or more logical combinations of the recipient name and each name in the name list.

10. The system of claim 9 further comprising a first notifying module configured to notify the sender that the electronic message is undeliverable if there are no matches between the one or more logical combinations of the recipient name and each name in the name list.

11. The system of claim 10 wherein the first notifying module comprises:
a second notifying module configured to notify a message handling module of the electronic message server of the recipient that there are no matches for the recipient name; and
a third notifying module configured to notify an electronic message server of the sender that the electronic message was undeliverable.

12. The system of claim 9 wherein the handling module comprises:
a determining module configured to determine if there are multiple matches between the one or more logical combinations of the recipient name and each name in the name list;
a first sending module configured to send a matched name from the name list to a message handling module of the electronic message server of the recipient if there is only one match;
a second creating module configured to create a notification of the receipt of the electronic message for a client of the recipient if there is only one match;
a notifying module configured to notify the message handling module that multiple matches have been found if there are multiple matches; and
a second sending module configured to send a notification to an electronic message server of the sender that multiple matches have been found if there are multiple matches.

13. A system for routing an incoming electronic message from a sender to a recipient where an electronic message address of the recipient fails to match a naming convention applicable to the recipient, comprising:
a receiving module configured to receive a recipient name of the electronic message address of the recipient;
a first creating module configured to create one or more logical combinations of each entry of a name list in the electronic message server of the recipient according to one or more naming conventions;
a comparing module configured to compare each of the one or more logical combinations of each entry of the name list with the recipient name; and
a handling module configured to handle the electronic message for delivery to the recipient if there are one or more matches between the one or more logical combinations of each entry of the name list and the recipient name.

14. The system of claim 13 further comprising a first notifying module configured to notify the sender that the electronic message is undeliverable if there are no matches between the one or more logical combinations of each entry of the name list and the recipient name.

15. The system of claim 14 wherein the first notifying module comprises:
a second notifying module configured to notify a message handling module of the electronic message server of the recipient that there are no matches for the recipient name; and
a third notifying module configured to notify an electronic message server of the sender that the electronic message was undeliverable.

16. The system of claim 13 wherein the handling module comprises:
a determining module configured to determine if there are multiple matches between the one or more logical combinations of each entry of the name list and the recipient name;
a first sending module configured to send a matched combination to a message handling module of the electronic message server of the recipient if there is only one match;
a second creating module configured to create a notification of the receipt of the electronic message for a client of the recipient if there is only one match;
a notifying module configured to notify the message handling module that multiple matches have been found if there are multiple matches; and
a second sending module configured to send a notification to an electronic message server of the sender that multiple matches have been found if there are multiple matches.

17. A method for routing an incoming electronic message from a sender to a recipient where an electronic message address of the recipient fails to match a naming convention applicable to the recipient, comprising:
receiving a recipient name of the electronic message address of the recipient;
creating one or more logical combinations of the recipient name according to one or more naming conventions; and
comparing each of the one or more logical combinations of the recipient name with each name in a name list.

18. The method of claim 17 further comprising handling the electronic message for delivery to the recipient if there are one or more matches between the one or more logical combinations of the recipient name and each name in the name list.

19. A method for routing an incoming electronic message from a sender to a recipient where an electronic message address of the recipient fails to match a naming convention applicable to the recipient, comprising:
receiving a recipient name of the electronic message address of the recipient;
creating one or more logical combinations of each entry of a name list in the electronic message server of the recipient according to one or more naming conventions; and
comparing each of the one or more logical combinations of each entry of the name list with the recipient name.

20. The method of claim 19 further comprising handling the electronic message for delivery to the recipient if there are one or more matches between the one or more logical combinations of each entry of the name list and the recipient name.
